(19) United States
(12) Patent Application Publication
(10) Pub. No.: US 2020/0148310 A1
(43) Pub. Date: May 14, 2020

(54) MOVABLE PLATFORM WITH PULL-OUT STEP LADDER

(71) Applicant: OPACMARE S.r.l., Torino (IT)

(72) Inventor: Michele Grimaldi, Piossasco (Torino) (IT)

(21) Appl. No.: 16/676,941

(22) Filed: Nov. 7, 2019

(30) Foreign Application Priority Data
Nov. 13, 2018 (IT) 102018000010265

(51) Int. Cl. B63B 27/14; E06C 5/26; E06C 1/39

(52) U.S. Cl. CPC B63B 27/146; E06C 1/39; E06C 5/26

(57) ABSTRACT

A movable platform assembly for a boat comprises a base structure adapted to be fixed to the boat, a platform, an articulated system that connects the platform to the base structure, wherein the platform is movable between a raised position which is horizontally adjacent to the base structure, and a lowered position which is horizontally away from the base structure, and a pull-out step ladder comprising an articulated parallelogram structure to which a plurality of steps is hinged, the articulated parallelogram structure being connected to the platform and having an end adapted to be fixed to the boat. In the raised position of the platform the pull-out step ladder is arranged under the platform.

### CROSS-REFERENCE TO RELATED APPLICATION

This application claims priority to Italian Patent Application No. 102018000010265 filed Nov. 13, 2018, the entire contents of which is hereby incorporated in its entirety by reference.

### TECHNICAL FIELD

The present disclosure relates to movable platform assemblies comprising a base structure adapted to be fixed to a boat, a platform, an articulated system that connects the platform to the base structure, wherein the platform is movable between a raised position which is horizontally adjacent to the base structure, and a lowered position which is horizontally away from the base structure, and a pull-out step ladder comprising an articulated parallelogram structure to which a plurality of steps is hinged, said articulated parallelogram structure being connected to the platform and having an end adapted to be fixed to the boat.

### BACKGROUND

These assemblies are generally used to allow hauling and launching of a tender or similar type of marine vehicle to equip the boat, or to allow bathers access to the water.

The pull-out step ladder is configured to unfold automatically when the platform changes from the raised position to the lowered position. This facilitates access to the platform from the deck of the boat, even when the platform is in the lowered position. In a known solution, a seat is formed in the walking surface of the platform to accommodate the pull-out step ladder when the platform is in the raised position.

This known solution has some drawbacks. Firstly, if the platform is used to support a tender, care must be taken to ensure that the tender is positioned so as not to interfere with the movements of the pull-out step ladder. Secondly, when the platform is in the lowered position the seat for the pull-out step ladder becomes in fact an empty recess which could constitute a stumbling block for the users who transit on the platform.

### BRIEF SUMMARY

The present disclosure proposes a platform assembly configured to overcome these drawbacks.

This is achieved according to the present disclosure by a movable platform assembly of the type defined above, wherein in the raised position of the platform the pull-out step ladder is arranged below the platform.

In a movable platform assembly configured in this way, during movement from the raised position to the lowered position, the platform “climbs over” the pull-out step ladder, finally moving below it, while the pull-out step ladder moves from an approximately horizontal position to an inclined position to avoid interference with the platform.

Therefore, it is no longer necessary to make a seat for the step ladder on the walking surface of the platform, and moreover the movement of the ladder does not interfere with the portion of space above such a walking surface. The drawbacks described above in relation to the prior art are therefore overcome.

Preferred embodiments of the disclosure are also described.

Further features and advantages of the platform assembly according to the present disclosure will become apparent from the following detailed description, provided by way of non-limiting examples with reference to the drawings.

### BRIEF DESCRIPTION OF THE DRAWINGS

FIGS. 1-6 are sectional views of a platform assembly according to the present disclosure, in different operating positions;

FIG. 7 is a perspective view of a pull-out step ladder of the assembly of FIG. 1;

FIGS. 8 and 9 are enlarged scale views of details of the pull-out step ladder, when the platform assembly is in the position of FIG. 1 and of FIG. 2, respectively.

### DETAILED DESCRIPTION

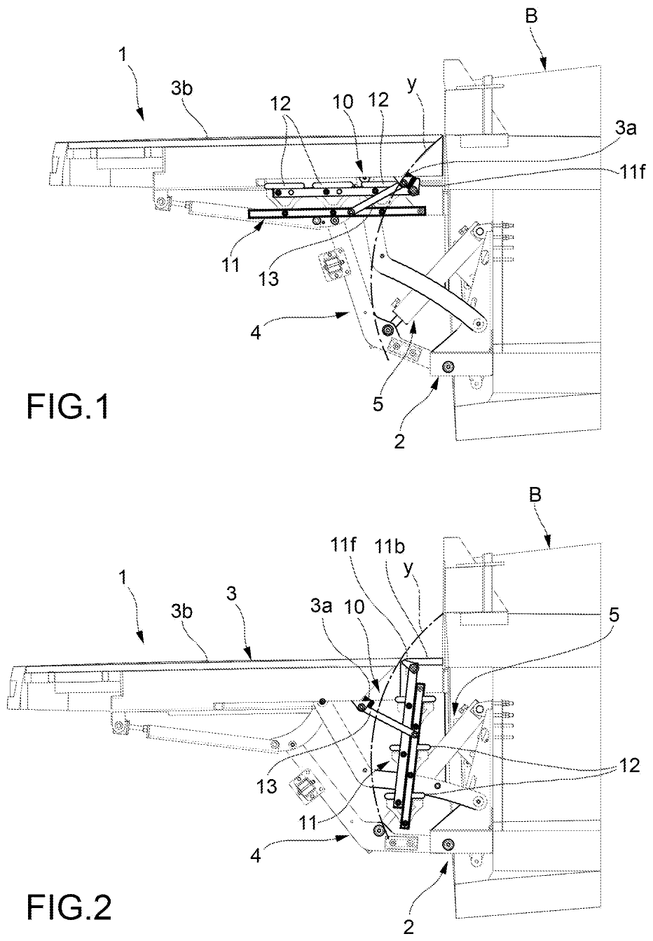

With reference to FIG. 1, a platform assembly 1 according to the present disclosure is shown, installed on a boat B. More generally, the present disclosure may relate to different platform assemblies installed on a fixed structure or on a vehicle.

The platform assembly 1 comprises a base structure 2, to which a platform 3 is connected. The base structure 2 may be provided with devices for fixing the platform assembly 1 to the fixed structure or vehicle, or, in an alternative embodiment, it may be incorporated in the fixed structure or in the vehicle.

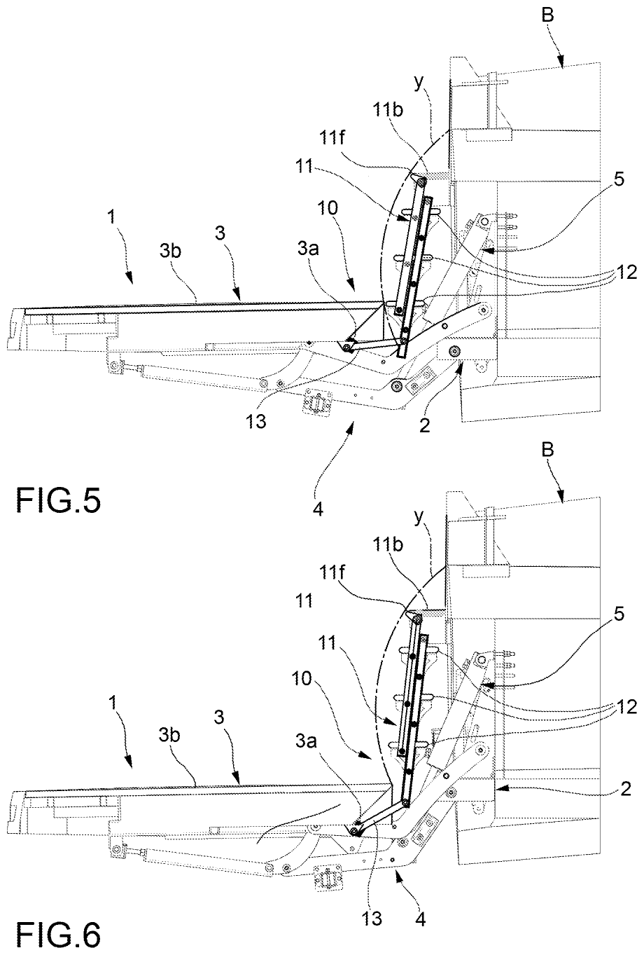

The platform assembly 1 further comprises an articulated system 4 known per se, which is formed by a plurality of rods hinged together and constrains through said rods the platform 3 to the base structure 2. The articulated system 4 is also associated to an actuator 5, by which the platform 3 is movable between a raised position horizontally adjacent to the base structure 2 (shown in FIG. 1), and a lowered position horizontally away from the base structure 2 (shown in FIG. 6). FIGS. 2-5 show intermediate positions of the platform.

The assembly further comprises a pull-out step ladder 10 which, in the raised position of the platform 3, is arranged below the platform 3.

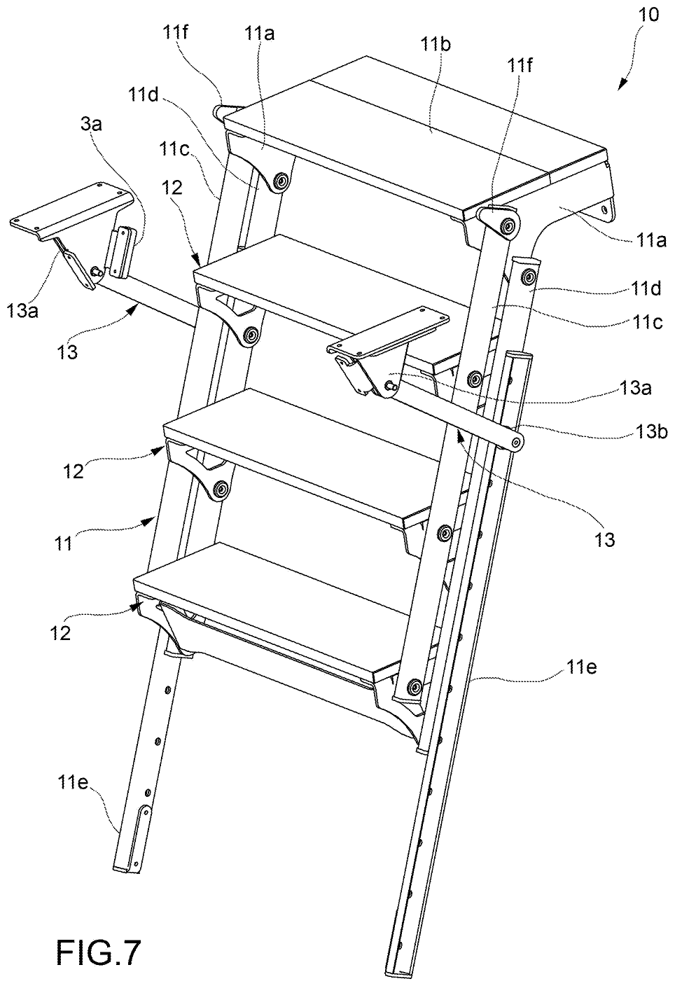

With reference in particular to FIG. 7, the pull-out step ladder 10 comprises an articulated parallelogram structure 11 to which a plurality of steps 12 is hinged. The number of steps 12 depends on the size of the assembly and the sinking height of the platform 3. The articulated parallelogram structure 11 comprises two sides of the ladder, each of which forms an articulated parallelogram. On each side there is a fixed element or frame 11a, on which a fixed step 11b of the ladder can be arranged. The fixed elements 11a can be separated from one another, or alternatively form a single fixed terminal structure together with the fixed step 11b.

In any case, the fixed elements 11a are adapted to be fixed to the boat.

On each side, the articulated parallelogram structure 11 comprises a first rod 11c and a second rod 11d, hinged to the frame 11a at the points xc and xd respectively. In the illustrated example, the hinging point xc of the first rod 11c is arranged at a higher height, and horizontally closer to the platform 3, with respect to the hinging point xd of the second rod 11d. The arrangement of the hinging points of the rods 11c and 11d may however be different from the one illustrated.

Each of the movable steps 12 is hinged both to the first rod 11c and to the second rod 11d, so as to define an articulated parallelogram together with the respective frame 11a.

The parallelogram structure 11 is connected to the platform 3 by a linkage 13. In the illustrated example, the linkage 13 comprises, on each side of the ladder, a connecting rod having a first end hinged to the platform 3 in point x3, in particular hinged to a bracket 13a fixed to the platform 3, and a second end 13b sliding along the articulated parallelogram structure 11. To this end, a guide 11e is fixed to the second rod 11d of the articulated parallelogram structure 11 in which a slider provided on the second end 13b of the connecting rod 13 is received.

On each side of the ladder, the first rod 11c comprises, at the frame 11a, a control extension 11f extending from the first rod 11c so as to form an angle with it.

The control extension 11f can be a separate piece fixed to the first rod 11c, or it can be made in a single piece with the first rod 11c. The control extension 11f integral with the first rod 11c is configured to rest by gravity against a support element 3a arranged on the platform 3, during an initial stretch of the movement of the platform 3 from the raised position to the lowered position. In the illustrated example, the support element 3a is arranged on the bracket 13a of the joint 13 intended to be fixed to the platform 3.

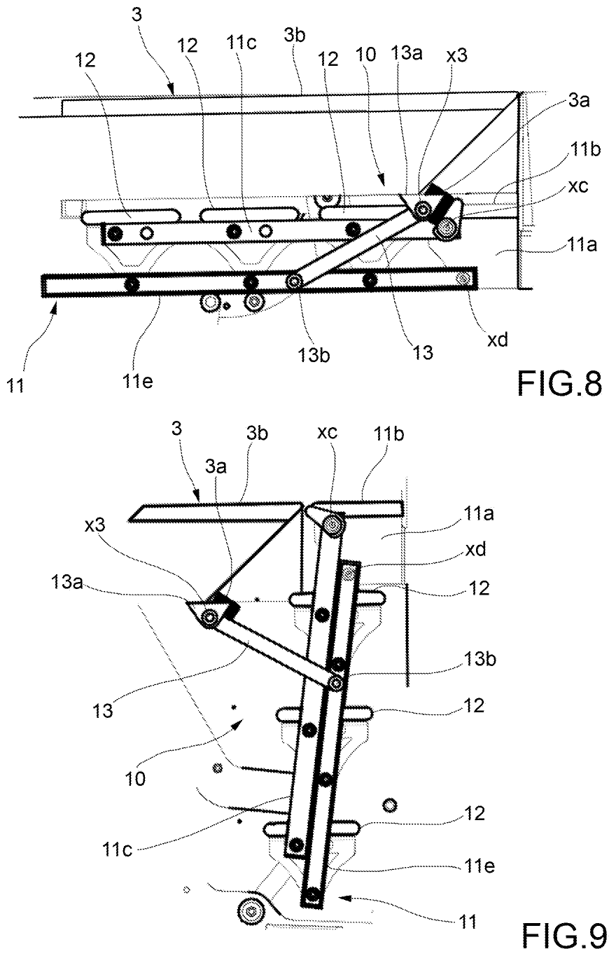

FIGS. 1 and 8 show the pull-out step ladder 10 with the platform 3 completely raised. In particular, the support element 3a integral with the platform 3, and the control extension 11f integral with the first rod 11c of the ladder, are in contact, keeping the ladder in a horizontal position, that is with the movable steps 12 coplanar.

By actuating the actuator 5, the platform 3 starts the descent, according to a trajectory determined by the articulated system 4 which connects the platform 3 to the base structure 2. In FIGS. 1-6, the trajectory of the platform 3 is indicated by a dashed line y, which represents the trajectory of a proximal edge of the platform 3.

When the platform 3 begins to descend, the support element 3a tends to detach itself from the control extension 11f and the ladder, due to its own weight, tends to fall with a rotation movement of the rods 11c and 11d around the respective hinging axes xc and xd, effectively maintaining the support element 3a and the control extension 11f in contact. This gives control over the descent speed of the ladder.

During the first step of movement of the platform 3 above, the connecting rod 13 rotates around the axis of rotation x3 of the hinging thereof on the bracket 13a, until the control extension 11f of the first rod 11c of the ladder is released from contact with the support element 3a. At this point, the connecting rod 13 is in a position almost perpendicular to the guide 11e. From this moment on, the position of the ladder 10 is controlled by the platform 3 by means of the connecting rod 13.

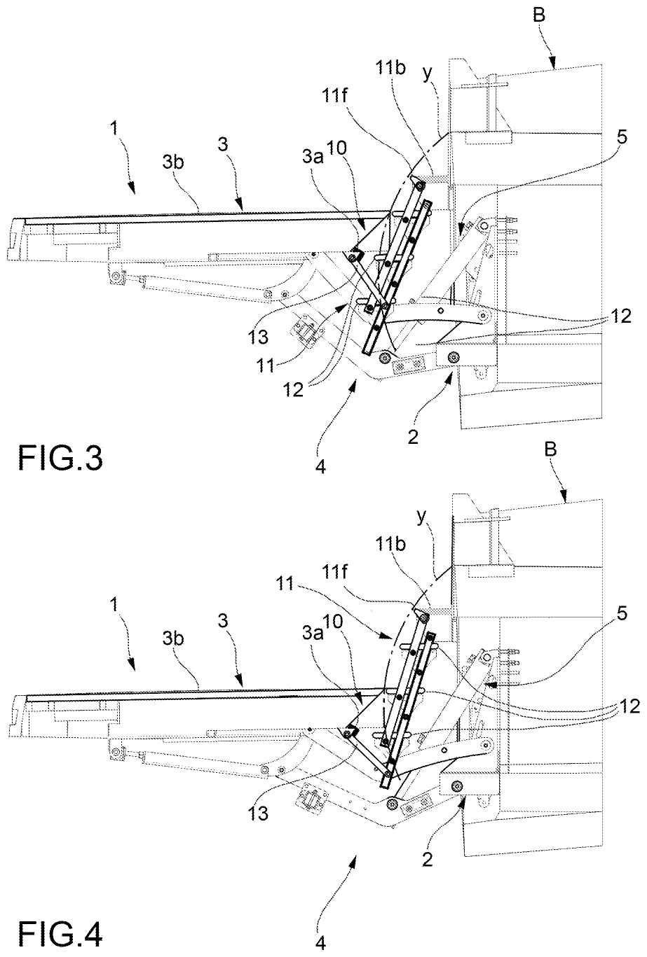

From the moment in which the walking surface 3b of the platform 3 reaches the level of the fixed step 11b of the ladder 10 (FIGS. 2 and 9), the position of the ladder 10 is kept almost unchanged (except for a small angular movement) while the platform 3 descends towards the fully lowered position (FIGS. 3-6). During this movement of the platform 3 the connecting rod 13 is free to slide inside the guide 11e, remaining close to a condition of perpendicularity to the guide 11e.

For the upward movement of platform 3 and closure of ladder 10, the process is the reverse of that described for the descent.

As can be seen, the movement of the ladder 10 is not directly dependent on the movement of the platform 3; however, the fact that the trajectory along which the platform 3 moves is binding for the smooth operation of the ladder 10 must be considered.

What is claimed is:

1. A movable platform assembly for a boat, comprising:
a base structure adapted to be fixed to the boat,
a platform,
an articulated system that connects the platform to the base structure, wherein the platform is movable between a raised position which is horizontally adjacent to the base structure, and a lowered position which is horizontally away from the base structure, and
a pull-out step ladder comprising an articulated parallelogram structure to which a plurality of steps is hinged, said articulated parallelogram structure being connected to the platform and having an end adapted to be fixed to the boat,
wherein in the raised position of the platform the pull-out step ladder is arranged under the platform.

2. The movable platform assembly of claim 1, wherein the articulated parallelogram structure is connected to the platform by a linkage.

3. The movable platform assembly of claim 2, wherein the linkage comprises a first end hinged to the platform and a second end slidable along the articulated parallelogram structure.

4. The movable platform assembly of claim 1, wherein the articulated parallelogram structure comprises a frame adapted to be fixed to the boat and a first rod hinged to the frame, said first rod comprising at the frame a control extension extending from the first rod to form an angle therewith, said control extension being configured to bear by gravity against un abutment element arranged on the platform, during an initial section of motion of the platform from the raised position to the lowered position.

5. The movable platform assembly of claim 4, wherein the articulated parallelogram structure further comprises a second rod hinged to the frame, each step of said plurality of steps being hinged to the first rod and to the second rod.
